(19) United States
(12) Patent Application Publication
(10) Pub. No.: US 2022/0221023 A1
(43) Pub. Date: Jul. 14, 2022

(54) ROTATING HYDRAULIC DAMPER

(71) Applicant: ARABULL, Zviad, Kiev (UA)

(72) Inventor: Zviad ARABULI, Kiev (UA)

(21) Appl. No.: 17/612,885

(22) PCT Filed: May 27, 2020
(86) PCT No.: PCT/UA2020/000058

§ 371 Date: Nov. 19, 2021

(30) Foreign Application Priority Data
May 28, 2019 (UA) A 2019 05856

(51) Int. Cl. F16F 13/00

(52) U.S. Cl. CPC F16F 13/007; F16F 13/00; F16F 2222/12; F16F 2232/02; F16F 2230/30; E05F 3/14; F16F 2230/08; B60G 2202/22; B60G 2202/24; B60G 2202/30; F16F 2230/36

(57) ABSTRACT

The disclosed invention relates to the mechanical engineering industry, in particular, transport, exercise and medical training machines or appliances. The rotary hydraulic damper has a body that is formed by two hermetically connected base members in the form of cups which are directed to each other by their open parts and installed on an axle and are suitable for reciprocal oscillations. Internal surfaces of the body form a cavity in which partitions with transfer holes are installed and divide the cavity into chambers at that one end of each partition is fixed in turn on an internal end face of one or another base member and opposite ends of the partitions remain free. The axle is unloaded and dampening takes place due to oscillations of the base members and transfer of working fluid from one chamber into another.

### CROSS REFERENCE TO RELATED APPLICATIONS

This application is a National Stage of PCT Application No. PCT/UA2020/000058 filed on May 27, 2020, which claims priority of Application No. a 2019 05856 filed in Ukraine on May 28, 2019 under 35 U.S.C. § 119; the entire contents of both of which are hereby incorporated by reference.

### FIELD OF INVENTION

The disclosed invention relates to the mechanical engineering industry, in particular, the transport engineering as well as the engineering of sports or medical devices for physical exercises. The invention may be used in transport vehicles for damping vibrations in suspension systems of transport vehicles with a deficiency of space for installation (for example, telescopic dampers) as well as in compact and versatile weight machines for rehabilitation of the human musculoskeletal system, devices for sports and athletic drills at home gym halls, marine vessels, spacecraft and so on. It can also be used as a damper in door or window wing closers.

### BACKGROUND

For unambiguous understanding of the terms used in the description and claims of the invention their definitions are given below:

‘Damper’ means the device for suppression (damping) of energy of mechanical vibrations in machine or mechanism parts and absorption of shocks or impacts of moving components, in particular, for retaining car wheels on the road and smoothing impacts on transport vehicle bodies, or damping of closing or opening devices. Recently dampers have been widely, used in weight machines as means of weight training. In the context of this description the term is tantamount to the shock absorber.

‘Means for attaching to external parts’ means elements that attach a damper to machine or mechanism parts which are required for suppressing (damping) energy of mechanical vibrations.

‘Hub’ means a central part in a base member or midline base member with a hole for installation of an axle.

‘Rod’ means an elongated object that is predominantly an axial or supporting member of other objects.

‘Axle’ means a part of device (a rod) designed for connecting components with each other; it rests upon supports and is used for ensuring rotary motion without torque transmission (unlike a shaft).

‘Shaft’ means a part (in the form of a rod) of machines or mechanisms; it rotates around its longitudinal axis in bearings and is intended for transmitting motion to the attached parts of the machine or mechanism whose component it is; at that it transfers torque along its axis and ensures rotating of machine components arranged on it.

‘Journal’ means a part of an axle; it contacts with a bearing; the journal at the end of an axle is called ‘stub’.

The disclosed invention has been created on the basis of lever-type shock absorbers that have been applied from the beginning of the 20^{th} century. Such shock absorbers are known from the following patents: FR394081A (issued in 1909), U.S. Pat. No. 933,076 (issued in 1909), U.S. Pat. No. 1,499,660A (issued in 1924), U.S. Pat. No. 2,584,221 (issued in 1952), RU2394176C1 (issued in 2010), JP2012197862A (issued in 2012), UA112592C2 (issued in 2015), UA123643 (issued in 2018). Such a lever-type shock absorber comprises a body with cylindrical boring and a shaft with the diametrically opposite blades at that the shaft is installed in the body boring and can rotate about its axis. As a rule, two partitions are formed in the body boring. These partitions are diametrically directed and make up separate chambers together with the blades. The chambers are filled with working fluid. Holes are made in the partitions. A shaft journal is connected with a suspension lever. If running over an obstacle or pot-hole occurs the lever goes up or down accordingly and rotates the shaft and the blades. Thereafter some chambers decrease their volume and pressure rises in them while other chambers increase their volume and fluid pressure falls in them. The working fluid flows slowly through the holes from the chambers with higher pressure to the chambers with lower pressure. The chamber design provides for a valve device that opens and increases the flow of fluid from one chamber to another chamber when a specified pressure is attained. Such a device may be adjustable or non-adjustable.

The described designs are compact, easy-to-install at transport vehicles but have low performance, They feature a low rate of vibration dampening and are difficult-to-make. Therefore, recently they have been replaced by telescopic dampers (see Dobromirov V. N., Ostretsov A. V. Designs of dampers—M: MGTU ‘MAMI’, 2007, —47 p., P.P. 13-15). All designs described above have the inherent drawback that lies in the fact that the above designs absorb impacts through the damper shaft and as a result their bearings are frequently overloaded and fail. Sometimes even the shaft bending occurs. The transport vehicles equipped with such dampers have small travel of the wheels due to small travel of the blade in the damper chamber.

Also a design of rotary hydraulic damper is known (U.S. Pat. No. 2,683,598, issued in 1954); it differs from the designs described above in the method of fluid carryover which uses a projection on the shaft and a removable plate with profiled surface, at that the plate is fixed in the body and directed to the projection and comprises a crown; at that on impact with the shaft projection the plate minimizes the gap between the projection and the crown and when the crown deviates the gap between the removable plate and the projection increases. The rate of fluid flow through the gap between the projection and the removable plate is higher than the flow rate in the gap between the plate crown and the shaft projection. In such a manner the flow rate of damping fluid, and hence the damping process itself, is regulated. Filling the fluid and air into the two opposite sealed chambers is carded out through filling holes. The described damper as the dampers described earlier is compact, easy-to-install at transport vehicles in particular at aircraft, but it has all deficiencies described above: poor performance, low intensity of vibration dampening and manufacturing complexity.

Also a rotary hydraulic damper by U.S. Pat. No. 4,411,341(A) (issued in 1983) is known. It is the closest analog to the invention designs that are disclosed. The device is intended for installation between external movable parts and connection with them for damping the relative movement of these parts at least in one direction. The device comprises a body with end faces and one side surface which form a cavity inside the body. As a matter of fact, the cavity cross-section is of the form of circle. The body comprises two radial partitions arranged in the cavity between one internal end face and another internal end face. A rotor is placed inside the body. The rotor is designed with a possibility of oscillations relative to the body. The rotor is in the form of shaft on which elongated blades arranged diametrically in the radial direction are fixed. The blades and the partitions divide the body cavity into chambers. The chambers are filled with working fluid. Holes with valve devices are made in the rotor blades. During relative rotation of the body and the rotor the working fluid flows through the holes from one working chamber with higher pressure to the adjacent chamber with lower pressure. Means for attaching to external parts are arranged on the damper body and the damper rotor.

The closest analog, as the all dampers described earlier, absorbs impacts via the damper shaft therefore it has the same inherent deficiency, low reliability of the damper. The working travel of the damper is limited by angular movement of the shall which cannot be more than 90° due to its design features. In practice the presence of locking means in the damper for prevention of destruction of the rotor blades or the body partitions further limits the travel. The design features of the closest analog prevent further improvement of the damper's performance and increasing the rate of vibration dampening.

The present invention has an objective to provide such an embodiment of a rotary hydraulic damper in which a possibility to enhance its performance and reliability by structural alternations of the body and the rotor is ensured, in particular, the possibility to increase damper stiffness or operating angle of relative rotation of movable components up to 270°, if necessary. An increase in the angle of relative rotation of the movable components will ensure a possibility to apply this damper design in weight machines which have improved functionality and prevent any overburden of patients or sportsmen as well as to apply this damper design in door or window wing closers.

For the invention the specified objective is attained as follows. In common with the closest analog the disclosed rotary hydraulic damper comprises a hollow body with end faces and side surface, at that the cavity cross-section is, in effect, of the form of circle, a rod installed in the body between the end faces along a symmetry axis of the cavity and facilities for attaching to the external parts. There are partitions in the body cavity. They are designed in such a manner that divide the body cavity into chambers. The chambers are designed to be suitable for filling them with working fluid and ensure migration of the fluid through transfer holes.

The body is made of two base members which are of the form of cups that are directed to each other by their open sides and installed on a rod that is in the form of an axle and are suitable for reciprocal oscillations. The base members are hermetically connected by their open sides in such a manner that their end faces are the body's end faces, their side surfaces form the body's side surface and the internal surfaces form a cavity. The partitions are fixed on an internal end face of one base member in turn, next after one. Their opposite ends have seals and are in contact with the internal end face of the opposite base member. There are transfer holes in the partitions. Means for attaching to external parts are provided on the outer surfaces of the base members.

As compared with the closest analog in the disclosed invention the rotary components are the body parts, that is the base members installed on the axle with a possibility of reciprocal oscillations, but not the shaft with blades. Therefore, in the disclosed damper the axle is unloaded, dampening is caused by oscillations of the base members and transfer of fluid from one chamber to another. This design significantly improves reliability of the damper. Arrangement of the means for attaching to external parts on the outer surfaces of the base members also improves operating conditions of the axle and reliability of the damper. In addition, the damper design provides for setting up several chambers according to its designation and service conditions. This design ensures a possibility to produce dampers of variable stiffness: the greater number of partitions results in the greater damper stiffness. Hence, the disclosed design may be used in transport vehicles, weight machines or shock absorbers in door or window hinge-closers.

An embodiment of the rotary hydraulic damper is preferred if its base members comprise hubs and bearings, which are installed in the corresponding hub ends and contain the axle stubs: at that a bearing is installed in the hub ends, which are proximate to each other, one bearing for two base members, and this bearing ensures the relative motion of the base members. In addition, seals are provided in the peripheral and internal areas of surfaces of the base members which are proximate to each other.

A possible embodiment of the damper comprises an axle whose one end is rigidly fixed on the internal end face of one of the base members or made as its integral part. Another base member comprises a hub in which a bearing is installed, at that the bearing retains a stub of the second end of the axle. At that the parts of the base members that are proximate to each other are connected by a bearing which is installed in them and ensures their reciprocal movement, and seals are provided in the peripheral and internal areas of surfaces of the base members which are proximate to each other.

For dampers that are not designed for operation under significant loads and for which the length of travel is important a preferred embodiment is one in which each base member design comprises a single partition, that is, there are two partitions in the body cavity. In this case the base members provide a possibility to oscillate within an angular range which can be calculated by formula: 360°/(n−1), where n is the number of partitions. Actually, if the thickness of partitions is taken into account the base members may oscillate in the range of up to 270° that significantly increases the length of travel and is desirable in weight machines or closers of door or window wings. In addition, a valve device may be arranged in one or both partitions. If a valve device is provided in each partition it is desirable to direct the valve devices in the partitions towards each other. This embodiment may be used when an increased force is required for dampening in one direction and a reduced force—in another direction.

The preferred embodiment of the damper is one in which a facility for regulating a cross-section area is provided in a transfer hole of the partition as a means for regulating the damper stiffness.

The preferred embodiment of the damper with increased damper stiffness is one in which torsional or compression springs are provided. The springs may be installed in the body cavity between the partitions or on the outer surface of the body. In the latter case the spring is designed with a possibility to be fixed on the means for attaching to external parts. For example, when levers are external parts the spring is equipped with a means for attaching between the levers.

If there is a need in visualization of forces affected the damper, for example during conduction of diagnosis of transport vehicle running gears, or visualization of muscle work in weight machines, the damper may comprise a pressure transducer installed in the body cavity. In addition, the damper may also comprise a movement pickup or acceleration transducer installed on the outer surface of one of the base members.

### BRIEF DESCRIPTION OF THE DRAWINGS

The essence of the invention is explained with the use of examples of actual embodiments and drawings.

FIG. 1 shows a schematic view of the damper's cross section explaining its operating principle.

FIG. 2 shows a longitudinal section of the damper with internal seals on the axle.

FIG. 3 shows a longitudinal section of the second embodiment with internal seals in the body of base members of invention.

FIG. 4 shows an expanded view of the damper design shown in FIG. 2.

### DETAILED DESCRIPTION

A damper applied in a weight machine is shown as an example of the actual embodiment of the invention. The weight machine is designed as a rotary hydraulic damper, it comprises a hollow body that consists of two base members 1 and 2, which are of the form of cups that are directed to each other by their open sides. The base members 1 and 2 are installed on an axle 3 and hermetically connected by their open sides in such a manner that their end faces are the body's end faces, their side surfaces form the body's side surface. The internal surfaces form a cavity 4 whose cross section is in the form of circle. The axle 3 is installed along a symmetry axis of the cavity 4 and designed in such a manner that the base members 1 and 2, have a possibility to free oscillate against each other while retaining on the axle.

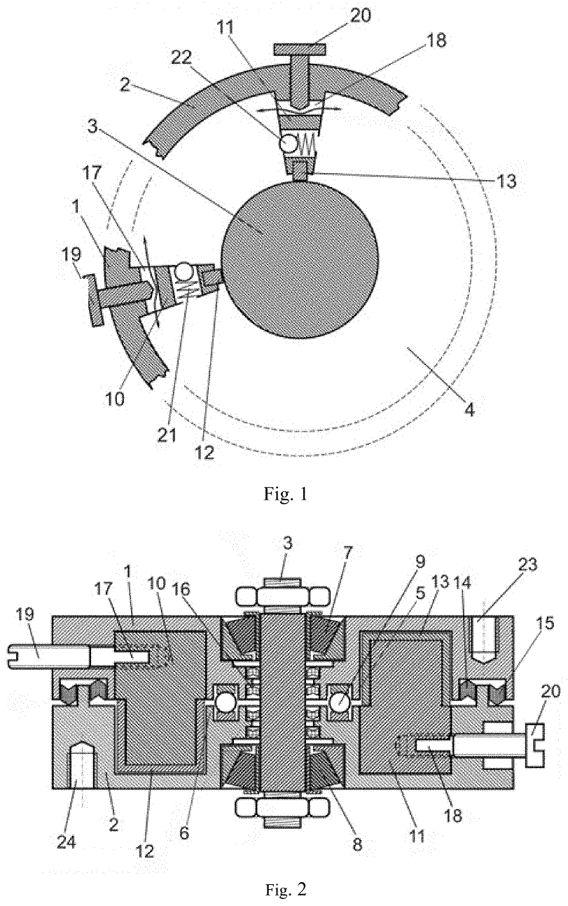

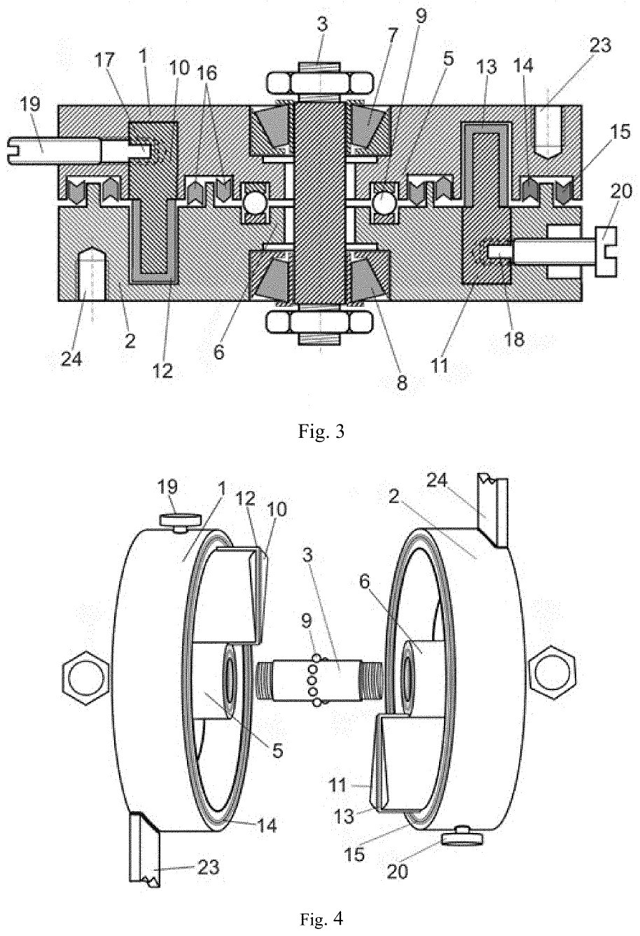

The partitions are fixed on an internal end face of one base member in turn, next after one. Their opposite ends have seals and are in contact with the internal end face of the opposite base member. There are transfer holes in the partitions. Means for attaching to external parts are provided on the outer surfaces of the base members. Reciprocal oscillations may be attained as FIG. 2 or FIG. 3 shows where the base members may oscillated against each other while the axle 3 may remain immovable. The axle may be even fixed on an immovable support. An embodiment is possible in which the axle 3 is designed as an integral part of the base member and oscillates simultaneously with this member.

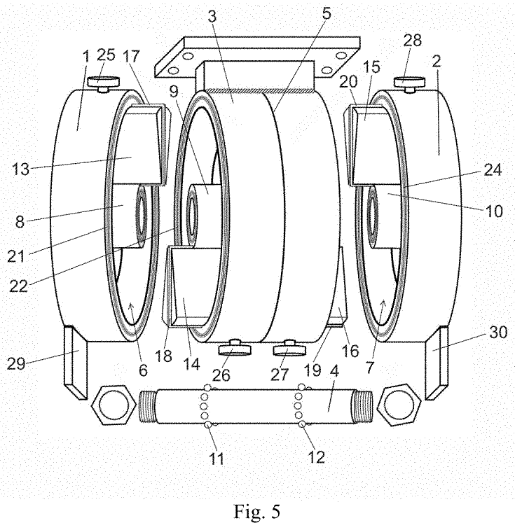

Hubs 5 and 6 are formed in the base members 1 and 2. Bearings 7 and 8 are installed in the hubs. These bearings, e.g. taper roller bearings, receive axial and radial loads, as shown in FIG. 2 or FIG. 3. Stubs of the axle 3 are installed in the bearings. A bearing 9 is installed on the axle between the hubs, it is a single bearing for the both base members which ensures their relative movement. In the example of the actual embodiment shown in FIG. 2 or FIG. 3 a thrust ball bearing is installed. Two partitions 10 [symbol] 11 are installed in the cavity 4. One end of the partition 10 is irremovably fixed on the internal end face of the base member 1 and the opposite end of the partition 10 is free and has a seal 12 which is in contact with the internal surface of the opposite base member 2. One end of the partition 11 is irremovably fixed on the internal end face of the base member 2 and the opposite end of the partition 11 is free and has a seal 13. The partitions divide the body cavity into two chambers. When such a damper is used in transport vehicles the number of partitions may be more than two. Under operating conditions the chambers are filled with working fluid. Machine oil may be used as working fluid. Leak-tightness of the chambers is ensured by seals 14, 15 which are installed on a peripheral area of contiguous with each other surfaces of the base members 1 and 2 and seals 16 installed either on the axle 3 between the bearings 7, 8 (as shown in FIG. 2) or in the body of the base members 1 and 2 (as shown in FIG. 3). The seals make tight the internal part of the chambers. Transfer holes 17 and 18 are provided in the partitions 10 and 11. The damper may be designed with transfer holes either in a single partition or in the both partitions in accordance with purposes for which a gym machine is intended. Each of the transfer holes 17 and 18 has a facility (19 and 20 respectively) for adjusting the cross section area of the transfer hole. FIG. 1 shows that adjusting screws 19 and 20, which are screwed in thread holes on the side surfaces of the base members, may be such facilities. If working fluid is absent in the cavity or its quantity is not sufficient it may be filled in through these holes at the stage of setting up of the damper. The chambers of the damper may be filled with working fluids of various viscosity depending on the required damper stiffness. Valve devices 21, 22 are additionally arranged in the partitions. They are aligned toward each other. Torsional or compression springs may be provided for increasing damper stiffness in the structure (are not shown in the drawings). Such springs may be easily installed or removed as required. Facilities 23 and 24 for attaching to external parts are provided on the outer surface of the base members 1 and 2. The facilities for attaching to external parts may be in the form of places for screw fastening or welding or in the form of levers. FIG. 2 and FIG. 3 show the facilities 23 and 24 for attaching to external parts that are implemented as holes for fastening of levers. FIGS. 4 and 5 show the facilities in the form of levers.

The gym machine-damper operates as follows. At the preliminary stage the cavity chambers 4 are filled with working fluid. A patient or sportsman takes the levers by hands and moves them apart and together in turn. At that the base members 1 and 2 revolve against each other together with the partitions 10 and 11. At that the volume of one chamber decreases with a corresponding increase in internal pressure and the volume of another chamber increases with a corresponding decrease in pressure. Fluid from the chamber with increased pressure flows into the chamber with reduced pressure via the transfer hole 17 or 18. The force required to move the levers apart and together and hence the load force affecting muscles of the patient or sportsman may be regulated by the screws 19, 20 depending on viscosity of working fluid and the cross section of the transfer hole. At that the amount of effort upon movements will be the same both in one direction and the opposite direction. It enables training of opposite sets of muscles. When the partitions are provided with valve devices 21 and 22, which are directed towards each other, it is possible to obtain ‘idle’ running and ‘working’ running that is the movement in one direction will be accompanied by opening of the valves (ease movement) and the movement in the opposite direction will be at the closed valves (on-load). When only one lever is required for training the idle base member may be fixed to an unmovable support. In this case an embodiment of the damper with one base member which is made unmovable in regards to the axle will be advisable.

The gym machine-damper has the following advantages: versatility, reliability and possibility to regulate loads without device retrofitting. In gym machines with two partitions an angle of rotation of the base members may be up to 270°. At that overloading and traumatization of patients are impossible. When a sportsman trains with the use of bench pressing exercises and feels that his muscles are tired there is no need to hold a barbell some time for preventing its falling, he simply releases the levers.

When a larger load is required a torsional or compression spring may be easily installed between the levers. When loads shall be controlled a pressure transducer (it is clear that for this purpose the gym machine shall comprise a special hole) may be easily set into a gym machine or movement pickup or acceleration transducer may be easily installed on the outer surface of the base member. Pickup data may be transmitted to any recording devices or monitor displays.

The disclosed damper design may operate for the purpose specified as a device for dampening energy of mechanical vibrations and absorbing of shocks and impacts exerted by moving elements. Generally, several partitions and additional torsional and compression springs are used in dampers intended for transport vehicles. At that the dampers operate in the same way as described above. The disclosed damper design that operates in the same way as described above is used to open and close door wings. Valve devices 21, 22 are installed towards each other in the damper partitions. In opening they operate in the idle mode and in closing-in the operating mode holding back the closing wings.

1. A rotary hydraulic damper comprising a hollow body with end faces and side surface whose cross section is essentially in the form of a circle, a rod installed in the body along the symmetry axis of the cavity, means for attaching to external parts, partitions arranged in the body in such a manner that they divide the body cavity into chambers, at that the chambers are designed with a possibility to fill them with working fluid and transfer fluid through transfer holes,
wherein
the body consists of two base members that are in the form of cups directed to each other by their open parts and joined between themselves in such a manner that their end faces are the end faces of the body, their side surfaces form the body's side surface, and internal surfaces form a cavity, at that the base members are installed on a rod which serves as an axle while the members are able to oscillate against each other, partitions whose one end is fixed and such ends are fixed in turn, next after one, on the internal end face of one base member then in the internal end face of another base member while their opposite ends have seals and are in contact with the internal end face of the opposite base member, transfer holes which are made in the partitions, and means for attaching to external parts which are arranged on the outer surface of the base members.

2. The rotary hydraulic damper of claim 1, wherein hubs are designed in the base members at that bearings which support the axle stubs are installed in the hubs while a bearing is installed in the hub ends which are proximate to each other and this bearing ensures reciprocal movement of the base members, and in addition seals are installed in peripheral and internal parts of the surfaces of the base members which are proximate to each other.

3. The rotary hydraulic damper of claim 1, wherein one end of the axle is rigidly fixed on the internal end face of the first base member or designed as it integral part, the second base member comprises a hub in which a bearing that supports a stub of the second end of the axle is installed, at that parts of the base members which are proximate to each other and connected between themselves by a bearing which is installed in them and ensures their reciprocal movement and along with that seals are installed

4. The rotary hydraulic damper according to claim 1, wherein the damper comprises two partitions in the cavity and a valve device is provided in one of the partitions.

5. The rotary hydraulic damper according to claim 1, wherein there are two partitions in the cavity and in each partition a valve device is provided at that the valve devices in the partitions are directed towards each other.

6. The rotary hydraulic damper according to claim 1, wherein the transfer hole in the partition comprises a facility to adjust the cross section area.

7. The rotary hydraulic damper according to claim 1, wherein it comprises a torsional or compression spring located in the body between the partitions.

8. The rotary hydraulic damper according to claim 1, wherein it comprises a torsional or compression spring located on the outer surface of the body at that the spring is designed with a possibility to attach it to the means for attaching with the outer surface.

9. The rotary hydraulic damper according to claim 1, wherein it comprises a pressure transducer installed in the body cavity.

10. The rotary hydraulic damper according to claim 1, wherein it comprises a movement pickup, or speed pickup, or acceleration pickup installed on the outer surface of one of the base member.

11-18. (canceled)
